(19) United States
(12) Patent Application Publication
(10) Pub. No.: US 2011/0162748 A1
(43) Pub. Date: Jul. 7, 2011

(54) FLEXIBLE RISER INSTALLATION FOR CARRYING HYDROCARBONS USED AT GREAT DEPTHS

(76) Inventors: Henri Morand, Perth (AU); Jeroen Hugo Remery, Saint Germain en Laye (FR)

(21) Appl. No.: 13/055,782

(22) PCT Filed: Jul. 27, 2009
(86) PCT No.: PCT/FR2009/000932

§ 371 Date: Mar. 25, 2011

(30) Foreign Application Priority Data
Jul. 29, 2008 (FR) 0804312

(51) Int. Cl. F16L 11/00

(52) U.S. Cl. 138/109

(57) ABSTRACT

A riser installation having a flexible pipe (10) of the unbonded type. The pipe (10) is positioned vertically between, on the one hand, a mechanical connection (7′) at the top of the riser to a surface installation (3) and, on the other hand, a mechanical connection (6′, 6″, 6″″) at the bottom of the riser with the sea bed (5). Fluidic connections at the top and at the bottom connect the riser on the one hand to surface equipment and on the other hand to sea bed equipment (2). The bottom of the riser is at a depth of at least 1000 m where it experiences a maximum calculatable reverse end-cap effect F. Tensioning device (8) imposes at the bottom of the riser a reactive tension T greater than at least 50% or even 100% of the maximum calculatable reverse end-cap effect F developed at the bottom of the riser.

The present invention relates to a flexible riser installation for transporting hydrocarbons or other fluids at high pressure, and a method of producing such an installation.

The flexible pipes for transporting hydrocarbons, which are unlike rigid pipes, are already well known, and they generally comprise, from the inside to the outside of the pipe, a metal casing, to take up the radial crushing forces, covered with an internal polymer sealing sheath, a pressure vault to withstand the internal pressure of the hydrocarbon, layers of tensile armor to take up the axial tension forces and an external polymer sheath to protect the whole of the pipe and in particular to prevent the ingress of seawater into its thickness. The metal casing and the pressure vault consist of longitudinal elements wound with a short pitch, and they give the pipe its resistance to the radical forces whereas the tensile armor layers consist of wires, generally metallic, wound with a long pitches so as to take up the axial forces. It should be noted that, in the present application, the concept of winding with short pitch designates any helical winding with a helix angle close to 90°, typically between 75° and 90°. The concept of winding with long pitch covers the helix angles below 55°, typically between 25° and 55° for the tensile armor layers.

These pipes are intended for the transportation of hydrocarbons, notably in the seabeds and do so at great depths. More specifically, they are said to be of the unbonded type and they are thus described in the normative documents published by the American Petroleum Institute (API), API 17J and API RP 17B.

When an unbonded pipe, regardless of its structure, is subjected to an external pressure which is higher than the internal pressure, compression forces are produced in the wall of the pipe that are oriented parallel to the axis of the pipe and that tend to shorten the length of the pipe. This phenomenon is called “reverse end-cap effect”. The intensity of the axial compression forces is roughly proportional to the difference between the external pressure and the internal pressure. This intensity may reach a very high level in the case of an unbonded flexible pipe submerged at a great depth, because the internal pressure may, in certain conditions, be very much lower than the hydrostatic pressure.

In the case of a flexible pipe of conventional structure, for example conforming to the normative API documents, the reverse end-cap effect tends to induce a longitudinal compression force in the wires forming the tensile armor layers, and to shorten the length of the flexible pipe. Furthermore, the flexible pipe is also subjected to dynamic bending stresses, in particular during installation or in service in the case of a riser, that is to say, a pipe forming the connection between a surface installation at sea level or in its vicinity, and a seabed installation. Together, these stresses may cause the wires of the tensile armor layers to buckle and irreversibly disorganize the tensile armor layers, thus ruining the flexible pipe.

Structural enhancements for the flexible pipes were therefore sought to increase the resistance of the armor layers to axial compression.

Thus, the document WO 03/083343 describes such a solution which consists in winding tapes reinforced, for example, with aramid fibers around the tensile armor layers. In this way, the swelling of the tensile armor layers is limited and controlled. However, while this solution resolves the problems associated with the radial buckling of the wires forming the tensile armor layers, it can only limit the continuing risk of lateral buckling of said wires.

The document WO 2006/042939 describes a solution which consists in using wires that have a high width-to-thickness ratio and in reducing the total number of wires forming each tensile armor layer. However, while this solution reduces the risk of lateral buckling of the tensile armor layers, it does not totally eliminate it.

The application FR 2 904 993 in the name of the applicant discloses a solution consisting in adding, inside the structure of the flexible pipe, a tubular axial immobilizing layer. This layer is designed to take up the axial compression forces and limit the shortening of the pipe, which makes it possible to avoid damage to the tensile armor layers.

These solutions are effective but present a certain number of constraints, notably financial, which lead to the requirement for alternative solutions, at least in specific cases, and notably in the particular case of risers.

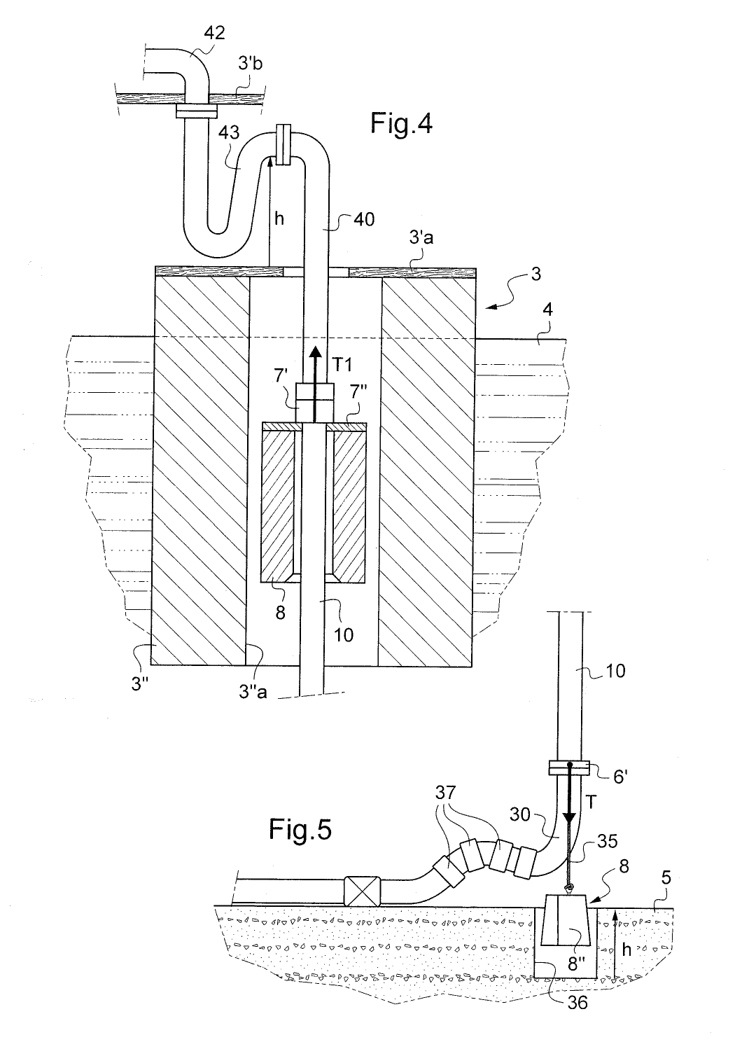

Different flexible riser configurations are known. The commonest configurations are represented in FIG. 4 of the normative document “API RP 17B, Recommended Practice for Flexible Pipes; Third Edition; March 2002”. They are known to those skilled in the art by the names “Free Hanging”, “Steep S”, “Lazy S”, “Steep Wave” and “Lazy Wave”. Another configuration, known by the name “Pliant Wave®” is described in the U.S. Pat. No. 4,906,137.

In the “Steep S”, “Lazy S”, “Steep Wave”, “Lazy Wave” and “Pliant Wave®” configurations, the flexible riser is supported, at an intermediate depth between the seabed and the surface, by one or more positive buoyancy members of the submarine arch or buoy type. This gives the flexible riser an S- or wave-shaped geometry, which enables it to withstand the vertical movements of the surface installation without generating excessive curvatures of said pipe, particularly in the region located close to the seabed, said excessive curvatures moreover being likely to damage said pipe. These configurations are generally reserved for dynamic applications at a depth of less than 500 m.

In the “Free Hanging” configuration, the flexible riser is positioned in catenary fashion between the seabed and the surface installation. This configuration offers the advantage of simplicity, with the drawback of being ill-suited to dynamic applications at shallow depth, because of the excessive curvature variations that can be generated close to the seabed. However, this configuration is commonly used for applications at great depths, that is to say more than 1000 m, even 1500 m. In practice, in these conditions, the relative amplitude of the movements of the floating support, and particularly of the vertical movements associated with the swell, remains very much less than the length of the catenary, which limits the amplitude of the curvature variations close to the seabed and makes it possible to control the risks of pipe fatigue. However, to guarantee the resistance of the flexible pipe to the reverse end-cap effect, which may, at these great depths, reach a very high level, the structure of the pipe must be engineered according to the abovementioned known techniques, which results in complex and costly solutions.

Also known are hybrid risers that use both rigid pipes and flexible pipes. Thus, the documents FR 2 507 672, FR 2 809 136, FR 2 876 142, GB 2 346 188, WO 00/49267, WO 02/053869, WO 02/063128, WO 02/066786 and WO 02/103153 disclose a riser of hybrid tower type, known to those skilled in the art by the name “Hybrid Riser Tower”. One or more rigid pipes rise along a substantially vertical tower from the seabed to a depth close to the surface, a depth from which one or more flexible pipes provide the link between the top of the tower and the floating support. The tower is provided with buoyancy means to remain in the vertical position. These hybrid towers are mainly used for applications at great depths. They have the drawback of being difficult to install. In particular, the sea installation of the rigid section generally requires very powerful lifting means.

Also known are rigid catenary risers, called SCR (Steel Catenary Riser). These risers formed by metal tubes are simpler and usually less expensive than the flexible risers. However, they withstand dynamic stresses less well and are in practice reserved for very stable floating supports such as those known in the art by the names SPAR (see in particular U.S. Pat. No. 6,648,074 and U.S. Pat. No. 7,377,225), TLP (Tension Leg Platform) or the deep draft semi-submersible platforms such as EDP (Extendable Draft Platform, see in particular U.S. Pat. No. 6,024,040 and U.S. Pat. No. 6,718,901). These drilling and production platforms, because of their stability, make it possible to transfer the manifolds to the surface (so-called “dry tree” solution). In the case of floating supports of ship type (FPSO, “Floating Production Storage and Offloading”) or standard semi-submersible platforms, the movements induced by the swell and the waves are greater and, in this case, it is generally preferred to have the manifolds on the seabed (so-called “wet tree” solution) and use a riser comprising at least one flexible pipe section in one of the regions subject to dynamic bending stresses. Risers that address this criterion are typically 100% flexible conventional risers (catenary, Lazy S, Lazy Wave, Steep S, Steep Wave, Pliant Wave®) but also “Tower Risers” (flexible pipes connecting the top of the rigid tower to the FPSO) and hybrid pipes in three parts, flexible-rigid-flexible, such as those described in EP 1078144.

However, until now, there has been no knowledge of riser installations produced using unbonded flexible pipe positioned vertically between a surface installation and a seabed and which can effectively withstand the reverse end-cap effect in deep water applications (that is to say, typically at more than 1000 m, even 1500 or 2000 m), without requiring costly structural modifications to the pipe. At these great depths, the end-cap effect is manifested with a very large amplitude because of the great hydrostatic pressure. When, in an installation for transporting hydrocarbons, notably in gaseous form, production is stopped, for example by closing a valve, the internal pressure in the pipe may drop and the difference between the high external hydrostatic pressure and the low or zero internal pressure may become considerable. These are the conditions that cause the reverse end-cap effect. If a flexible pipe is to be used in a conventional riser installation, there is therefore an obligation to adapt the structure of the pipe to be able to withstand the reverse end-cap effect at the riser bottom, which means having to engineer the reinforcing layers of the pipe accordingly, the bottom of the riser being the dimensioning part, which leads to an over dimensioning of the rest of the pipe and therefore an added cost.

The aim of the invention is to propose an unbonded flexible riser installation that is effectively resistant to the reverse end-cap effect despite the great depth but that does not require prohibitive structural modifications. The invention also aims to propose a method of installing this pipe at sea.

The invention achieves its aim by virtue of a riser installation produced using a flexible pipe of the unbonded type, said pipe comprising, from inside to outside, at least one internal sealing sheath and at least two layers of tensile armor wires wound with a long pitch, the pipe being positioned between, on the one hand, a mechanical connection at the top to a surface installation and, on the other hand, a mechanical connection at the bottom with the seabed, fluidic connections being provided at the top and at the bottom to connect the riser on the one hand to surface equipment and on the other hand to seabed equipment, characterized in that the flexible pipe is positioned with the bottom of the riser at a depth of at least 1000 m where it is subject to a maximum calculable reverse end-cap effect F and in that tensioning means are provided, designed to produce, at the bottom of the riser, a reactive tension T greater than at least 50% of the maximum calculable reverse end-cap effect F developed at the bottom of the riser.

The internal sealing sheath is understood to be the first layer, starting from the inside of the pipe, the function of which is to ensure seal-tightness with respect to the fluid circulating in the pipe. Generally, the internal sealing sheath is an extruded polymer tube. However, the present invention also applies to the case where said internal sealing sheath consists of a flexible and seal-tight metal tube, of the type disclosed in the document WO 98/25063.

In the present application, the reverse end-cap effect is given by the formula F=(Pext×Sext)−(Pint×Sint).

Pext is the hydrostatic pressure prevailing outside the pipe, in the region located close to the seabed. Pint is the minimum pressure prevailing inside the pipe, in the region located close to the seabed. It is the lowest internal pressure experienced by the pipe, throughout its service life, in the region located close to the seabed. This minimum pressure is usually assessed as early as the pipe design phase, because it conditions the dimensioning of the pipe. Sint is the internal transversal section of the internal sealing sheath to which the internal pressure is directly applied. Sext is the external transversal section of the sealing sheath to which the external pressure is directly applied.

In the case of a flexible pipe comprising only one seal-tight sheath, namely the internal sealing sheath, Sext is equal to the external transversal section of this sheath. In practice, the hydrostatic pressure is applied in this case directly to the external face of the internal sealing sheath. Flexible pipes conforming to this characteristic are notably described in the documents WO02/31394 and WO2005/04030. Such pipes may include a non seal-tight external polymer sheath which, because of its lack of seal-tightness, is not used in the calculation of F.

Generally, the flexible pipe comprises at least two seal-tight sheaths, namely, on the one hand, an internal sealing sheath with the internal pressure directly applied to the internal face thereof, and on the other hand another seal-tight sheath surrounding said internal sealing sheath and with the external pressure directly applied to the external face thereof.

Often, this other seal-tight sheath directly subjected to the hydrostatic pressure is the outermost layer of the flexible pipe, and it is then designated external sealing sheath. In this case, Sext is equal to the external transversal section of this external sealing sheath.

However, there are also flexible pipes, notably those with smooth bore, in which this other seal-tight sheath directly subjected to the hydrostatic pressure is an intermediate sealing sheath generally situated between the pressure vault and the internal layer of tensile armor wires. In this case, Sext is equal to the external transversal section of this intermediate sealing sheath directly subjected to the hydrostatic pressure.

As an example, if we consider a flexible pipe with rough bore consisting, starting from the inside and working toward the outside, of a metal casing, an internal polymer sealing sheath of internal diameter Dint, a pressure vault, a pair of tensile armor layers and an external polymer sealing sheath of external diameter Dext, the maximum calculable reverse end-cap effect F is given by the formula:

F=(Pext×πD²ext/4)−(Pint×πD²int/4).

By virtue of a tension T at the bottom of the riser which is much greater than that which the simple supporting of the flexible riser would justify, the reverse end-cap effect is at least partly compensated and an overworking of the tensile armor layers in compression is avoided, which makes it possible to simplify the structure of the pipe and therefore reduce its cost. Furthermore, it is thus possible to increase the accessible water depths without requiring major modifications to the known techniques for designing and manufacturing flexible pipes. The invention thus makes it possible to do away with the use of a tubular axial immobilizing layer of the type of that described in the application FR 2 904 993. It also makes it possible to eliminate or reduce the thickness of the anti-swelling layer or layers, layers described in particular in the document WO 03/083343, and the function of which is to limit the swelling of the tensile armor layers when the latter are subjected to a compression force. These anti-swelling layers generally consist of Kevlar® reinforced strips wound around the tensile armor layers. Because of the high cost of Kevlar®, reducing or eliminating these strips provides for a significant saving. Another advantage of the invention is to reduce the risk of lateral buckling of the tensile armorings, and therefore increase the depth at which the flexible pipes can be used as risers. This also makes it possible to avoid the use of tensile armor wires that have a high width-to-thickness ratio, which facilitates the manufacture of the pipes.

The present invention advantageously applies to any flexible pipe of the unbonded type, provided that the latter comprises at least one internal sealing sheath and one pair of tensile armor wires.

Advantageously, the tensioning means are designed to exert on the riser a tension T greater than at least 75% of the maximum reverse end-cap effect F developed at the bottom of the riser, and, even more advantageously, the buoy is dimensioned to exert on the riser a tension T greater than at least 100% of the maximum reverse end-cap effect F developed at the bottom of the riser. In the latter case, there is an assurance that the tensile armorings will never be compressed by the reverse end-cap effect and it is then particularly advantageous to choose to produce the flexible pipe with tensile armor wires made of composite material, based on carbon fibers for example, or glass fibers, or, more generally, any other composite material. Such tensile armor layers offer the advantage of lightness but withstand compression poorly. The invention makes it possible to use them for a riser, in return for these high tension precautions imposed by the tensioners according to the invention.

The inventive tensioning means may be incorporated in the surface installation and/or be located at the bottom of the riser.

When they are incorporated in the surface installation, they may comprise cylinder-operated tensioners, notably operated by hydraulic cylinders. They may also comprise a float fixed to the top nozzle of the pipe and that slides in a guide inside the surface installation.

When they are provided at the bottom of the riser, they advantageously comprise a weight connected to the bottom portion of the pipe, for example by means of weight suspension cable or ballast attachment clamps. The weight may be distributed over a certain length of the end of the pipe or be located at one point, for example at the level of the bottom nozzle. It may be a weight sliding into a well provided in the seabed.

Naturally, tensioning elements at the riser bottom and tensioning elements at the riser top can be combined.

The inventive riser is advantageously positioned vertically but it may also be suspended in catenary fashion and be held taut using weights positioned at the bottom of the pipe.

An installation according to the invention also advantageously offers one or more of the following characteristics:
The internal sealing sheath of the vertical flexible pipe is polymeric.
The vertical flexible pipe comprises an external polymer sealing sheath surrounding the layers of tensile armor wires.
The hydrostatic pressure is directly applied to the external face of the internal sealing sheath, or even to the external face of an intermediate sheath or of an external sheath.
The vertical flexible pipe comprises, between the internal sealing sheath and the layers of tensile armor wires, an internal pressure vault produced by a helical winding with short wire pitch, intended to withstand the internal pressure of the fluid being transported.
The layers of tensile armor wires of the vertical flexible pipe comprise layers of wires made of carbon-fiber-based or glass-fiber-based composite material.
The mechanical connection at the bottom comprises at least one anchoring cable connecting the bottom of the flexible vertical pipe to an anchor point fixed to the seabed. This anchoring cable may be replaced by any equivalent connecting means, offering both high mechanical tensile strength and good bending flexibility, such as, for example, a chain or an articulated mechanical device.
The fluidic connection at the bottom comprises a flexible connecting pipe at the bottom connecting the bottom of the riser to a production pipe, via appropriate nozzles and accessories.
The fluidic connection at the bottom is made by a bottom connecting nozzle fixed to the bottom of the flexible vertical pipe, and the at least one anchoring cable mentioned above is firmly attached at its top end to said bottom connecting nozzle.
Said flexible connecting pipe at the bottom has distributed buoyancy.
The fluidic connection at the top generally comprises a flexible connecting pipe at the top connecting the top of the riser to the surface equipment, via appropriate nozzles and accessories.
The surface installation is notably of platform, semi-submersible, SPAR or FPSO type.

The invention also relates to a method of installing the installation according to the invention.

It therefore concerns a method of installing a riser installation produced using a flexible pipe of the unbonded type, said pipe comprising, from inside to outside, at least one internal sealing sheath and at least two layers of tensile armor wires wound with a long pitch, the pipe having to be positioned between on the one hand a mechanical connection at the top to a surface installation and on the other hand a mechanical connection at the bottom with the seabed, fluidic connections having to be provided at the top and at the bottom to connect to the riser on the one hand to surface equipment and on the other hand to seabed equipment, the method being characterized in that the bottom of the riser is positioned at a depth of at least 1000 m where it is subject to a maximum calculable reverse end-cap effect F and in that tensioning means are provided to produce at the bottom of the riser a reactive tension T greater than at least 50% of the maximum calculable reverse end-cap effect F developed at the bottom of the riser.

Advantageously, the flexible pipe is filled with water while being laid.

Other particular features and advantages of the invention will emerge from reading the indicative but nonlimiting description given below, with reference to the appended drawings in which:

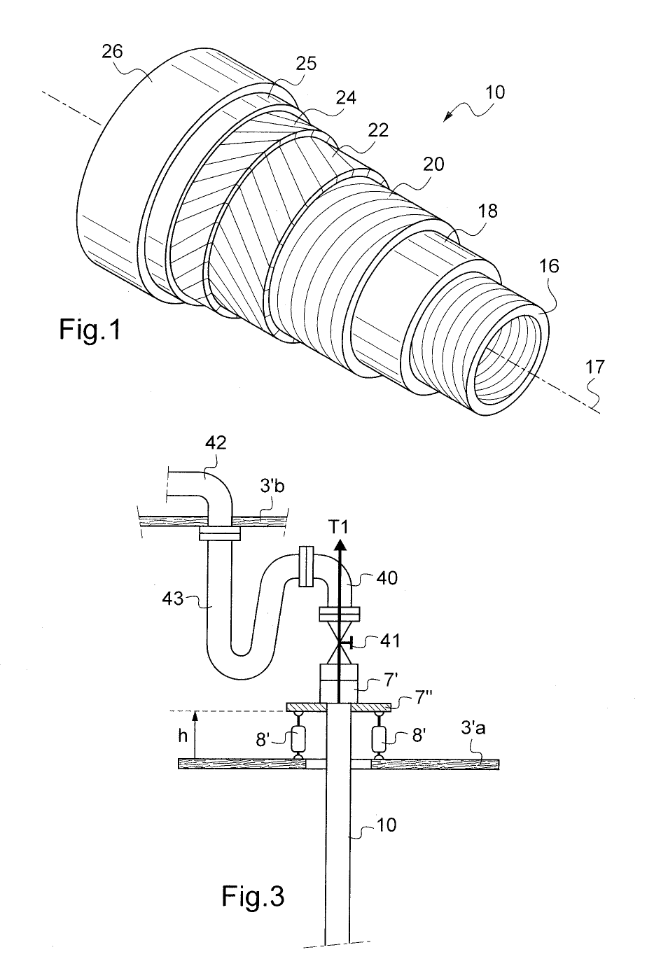

FIG. 1 is a partial perspective schematic view of a flexible pipe that can be used according to the invention;

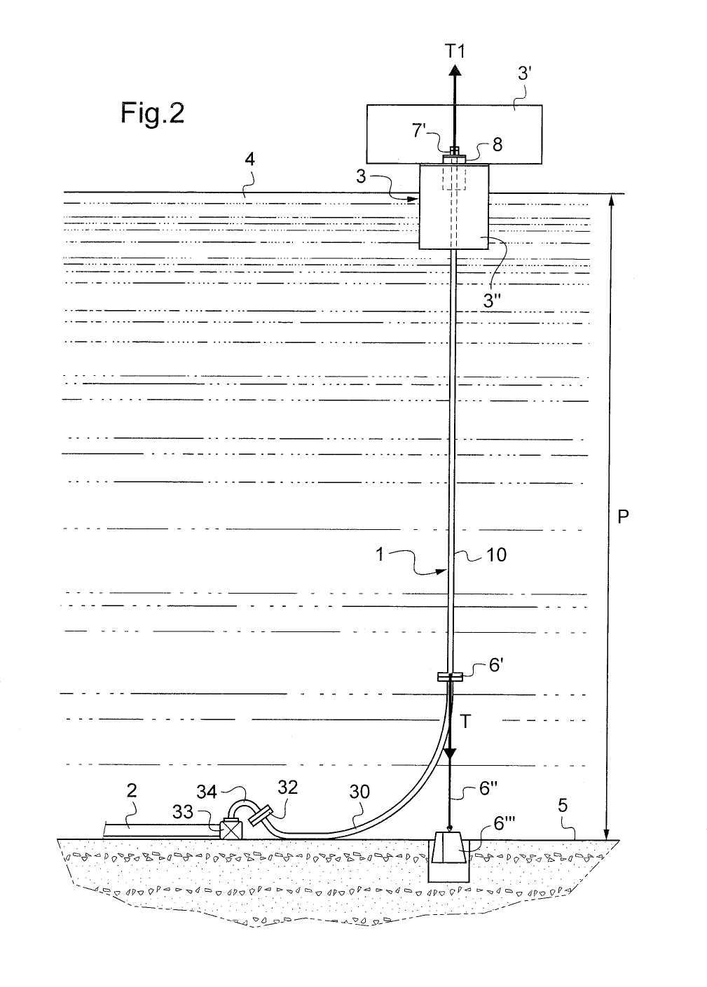

FIG. 2 is a schematic view in elevation of a riser installation according to the invention;

FIG. 3 is a more detailed view of a first embodiment of the tensioning means, at the top of the pipe;

FIG. 4 is a more detailed view of a second embodiment of the tensioning means, at the top of the pipe;

FIG. 5 is a more detailed view of a third embodiment of the tensioning means, at the bottom of the riser;

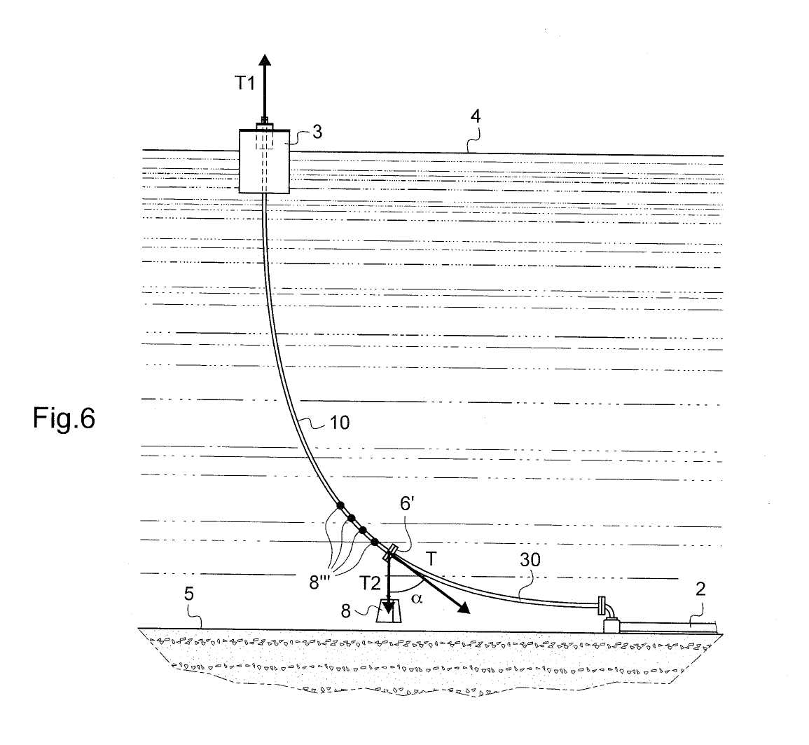

FIG. 6 is a schematic view in elevation of a flexible pipe suspended in catenary fashion and held taut via the bottom.

FIG. 1 illustrates an unbonded flexible pipe 10 of the rough-bore type and which in this case has, from the inside of the pipe to the outside, an internal metal casing 16, a plastic internal sealing sheath 18, a clamped pressure vault 20, two crossed layers of tensile armor 22, 24, an anti-swelling layer 25 produced by winding strips with high mechanical strength, such as, for example, woven strips of Kevlar® fibers, and an external sealing sheath 26. The flexible pipe 10 thus extends longitudinally along the axis 17. The internal metal casing 16, the clamped pressure vault 20 and the anti-swelling layer 25 are produced using longitudinal elements helically wound with a short pitch, whereas the crossed armor layers 22, 24 are formed by helical windings with a long armor wire pitch.

In another type of pipe, with smooth bore, the metal casing 16 is eliminated and an intermediate sealing sheath is generally added between on the one hand the pressure vault 20 and on the other hand the internal armor layer 22. It can also be noted that some flexible pipes do not include any pressure vault but acquire their resistance to pressure through a particular armor winding, wound at a favorable angle, for example 55°.

FIG. 2 schematically represents the inventive riser 1 intended to raise a fluid, in theory a liquid or gaseous, or two-phase hydrocarbon, between a production installation 2 situated on the seabed 5 and an operation installation 3 floating on the surface 4 of the sea, for example of the SPAR type comprising a platform 3′ proper with a number of decks, supported on a float 3″. The production installation 2 represented in FIG. 2 is a pipe, generally rigid, resting on the seabed and known to those skilled in the art by the name “flowline”. This pipe provides the link between on the one hand the bottom of the riser 1, and on the other hand a submarine installation of the manifold or well head type.

The riser mainly consists of a vertical portion of flexible pipe 10 held taut between a mechanical connection 6′, 6″, 6′″ attaching it to the seabed 5 at the bottom of the riser and a mechanical connection 7′, 7″ attaching it to tensioning means 8, in this case at the top of the riser (so-called “topside” configuration), schematically represented in FIG. 2 and in more detail in FIG. 3. The function of the attachment means 7′, 7″ is to transmit to the top part of the flexible pipe the tensile forces generated by the tensioning means 8. The function of the mechanical attachment means 6′, 6″, 6′″ is to anchor the base of the flexible pipe 10 to the seabed 5.

In a typical installation considered by the applicant, the depth P of the sea is greater than 1000 m and may for example reach 3000 m. The tensioning means 8 exert, at the top of the riser, on the latter, a tension T1 directed upwards. Given the apparent weight of the pipe in water, the intensity of the reactive force T exerted at the bottom of the riser at the level of the fixing 6′ is the difference between the tension T1 at the top and the relative apparent weight of the riser.

According to the present invention, the tensioning means 8 are designed in such a way that the resultant tension T applied to the bottom part of the flexible riser is sufficiently great to compensate at least 50%, advantageously 75% and preferably 100% of the axial compression force generated by the reverse end-cap effect.

According to the invention, the tension imposed on the riser may exceed 70 000 daN, even 100 000 daN, or even 200 000 daN, which is a very high value. Obviously, this means that tensioning means must be used, which impose an added cost on the installation, but they also provide a greater saving on the structure of the vertical flexible pipe 10, this advantage more than compensating for the drawback associated with the added cost of the tensioning means.

The following example illustrates this point. Let us consider a vertical flexible pipe 10 carrying gas, with an internal diameter of 225 mm and an external diameter of 335 mm, and extending between the seabed situated at a depth P=2000 m and the surface installation. Let us also assume that, if production is stopped, the pressure inside the pipe can drop to 1 bar, in the region situated close to the seabed, this internal pressure moreover being the minimum pressure planned for the duration of the life and operation of the pipe. The hydrostatic pressure at the bottom of the pipe is roughly equal to 200 bar. Consequently, in this example:

Pext=200 bar=2 daN/mm²

Pint=1 bar=0.01 daN/mm²

Dext=335 mm

Dint=225 mm

So that the maximum reverse end-cap effect is:

F=(2×π×335²/4)−(0.01×π×225²/4)≈176 000 daN

If the invention were not applied, it would therefore be necessary to dimension the pipe to withstand a reverse end-cap effect of the order of 180 000 daN to include the safety margins. In practice, in this example, this would have led to the choice of a structure comprising two steel tensile armor layers 22, 24, each 4 mm thick, and an anti-swelling layer 25 made of very thick Kevlar®. The steel wires forming the tensile armor layers would also have exhibited a high width-to-thickness ratio, typically 20 mm by 4 mm, to avoid the lateral buckling of the tensile armor layers. The weight in the water of such a pipe, when full of gas, would then be of the order of 100 daN per linear meter, which would have led to a total weight of 200 000 daN.

According to a first embodiment of the invention, the tension T at the bottom of the riser is equal to 50% of F, that is to say 88 000 daN. The flexible pipe 10 must in this case be dimensioned to withstand an axial compression force of the order of 90 000 daN instead of the abovementioned 180 000 daN according to the prior art. This strong reduction in the axial compression makes it possible in this example to choose a structure comprising two steel tensile armor layers 22, 24 each 3 mm thick, and consisting of conventional wires that do not have a high width-to-thickness ratio. The thickness of the anti-swelling layer 25 made of Kevlar® is in this case almost two times lower than that according to the abovementioned prior art. The weight in water of such a pipe, when full of gas, is of the order of 90 daN per linear meter, that is to say, substantially less than that of a pipe according to the above-mentioned prior art. The total weight in water of the pipe 10 therefore approximates to 180 000 daN.

According to a second particularly advantageous embodiment of the invention, the tension T at the bottom of the riser is equal to F, that is to say 176 000 daN.

In this case, given that the reverse end-cap effect F is totally compensated and that the compressing of the tensile armor layers 22, 24 is avoided, it is possible and advantageous to choose for them wires made of composite material, preferably based on carbon fibers. Reference can, for example, be made to the document U.S. Pat. No. 6,620,471 in the name of the applicant, disclosing composite strips comprising composite fibers embedded in a thermoplastic matrix. Such armorings provide high tensile strength and result in a flexible pipe that is lighter than metal armorings. On the other hand, since they are poorly resistant to compression, they can be used only in conditions where the risk of compression is precluded, which is the case with the invention which makes it possible to always keep the armorings taut.

The use of tensile armorings made of carbon fibers instead of steel armorings makes it possible not only to lighten the pipe, which facilitates its handling and its installation at sea, but also to enhance its corrosion-resistance and to avoid the hydrogen-embrittlement phenomena encountered with steels with high mechanical specifications. According to other embodiments, it is possible to use armorings made of glass-fiber-based composite material. The absence of axial compression also makes it possible to eliminate the anti-swelling layer 25 made of Kevlar®, which provides for a significant saving. The weight in water of such a pipe, when full of gas, is in this example of the order of 60 daN per linear meter, which represents a 40% weight saving compared to the above-mentioned prior art. The overall weight in water of the pipe 10 therefore approximates to 120 000 daN.

There now follows a more detailed description of how some of the equipment of the installation according to the invention is produced.

FIG. 2 shows connection means at the bottom which ensure the continuity of the flow of the fluid carried between on the one hand the submarine production installation 2 and on the other hand the bottom part of the vertical flexible pipe 10 at the level of the nozzle 6′. These means comprise a connecting pipe 30 at the bottom, usually short, in practice less than 100 m. This connecting pipe at the bottom must be dimensioned to withstand all of the reverse end-cap effect. This connecting pipe at the bottom may comprise one or more rigid or flexible pipe sections, possibly in combination. It may also comprise a mechanical device of the flexible seal type, a device whose function is to ensure the continuity of the flow while allowing degrees of freedom in bending similar to those of a flexible pipe. It is also possible to have other types of vertical connections, for example with a single flange and bend limiter to make up for the angle variations.

Advantageously, the connecting pipe 30 at the bottom is a flexible pipe reinforced according to the abovementioned prior art techniques, in order to withstand the reverse end-cap effect and eliminate the risk of lateral buckling of the tensile armor layers. The structure of this flexible connecting pipe 30 at the bottom is generally very different from that of the vertical flexible pipe 10. In FIG. 2, the flexible pipe 30 is connected at its bottom end via a nozzle 32 to the nozzle 35 of a rigid spool piece 34 allowing connection via the top with a vertical connector 33 placed at the end of the production pipe (flowline) 2 and cooperating with a suitable nozzle 36 of the spool piece 34. The top end of the flexible pipe 30 comprises a nozzle 31 connected to the bottom nozzle 6′ of the flexible pipe 10, which is fixed to an anchor point 6′″ via a cable or a chain 6″. The anchor point 6′″ is firmly attached to the seabed 5. It is dimensioned to withstand a pull-off tension greater than the tension T exerted by the bottom of the riser. The anchor point 6′″ is advantageously a suction pile anchor or a gravity anchor piling.

FIG. 3 shows the top vertical end of the flexible pipe 10 provided with a nozzle 7′ which rests on a thrust collar 7″ supported on hydraulic cylinders 8′ (forming the tensioning means 8) mounted vertically on deck 3′a of the platform 3′ and making it possible to vary the height h of the nozzle 7′ relative to the deck 3′a. The nozzle 7′ may be connected, through a valve 41, to a rigid bend 40, which is in turn linked by a coupling 43 to a nozzle 42 positioned on a deck 3′b of the platform (it may be the same deck as 3′a or another deck). The coupling 43 is a short flexible coupling (called “jumper” in the profession) to accommodate the variations of height h.

FIG. 4 represents the detail of a second embodiment of the tensioning means at the top of the riser. The nozzle 7′ of the flexible pipe 10 rests on an annular collar 7″ supported by an annular buoy 8 passed through by the flexible pipe 10 and guided in a central well 3″a of the float 3″ of the SPAR 3. The buoy 8 is submerged, but, unlike installations that use isolated buoys submerged to depths of 200 to 300 m under the surface 4 of the water, in order to avoid the marine currents, it is in this case a buoy guided by the surface installation 3 and therefore situated at a short distance from the latter but still insensitive to the marine currents given that it is protected by the central well 3″a. As in the preceding embodiment, the top part of the pipe 10 is connected to a rigid pipe 40 which passes through the bottom deck 3′a of the platform and leads, via a flexible coupling 43 taking up variations of height h, to a nozzle 42 connected to the manifold. The buoy 8 is dimensioned on the one hand to take up the weight of the submerged pipe and on the other hand to exert on the pipe 10 the tension needed to partly or totally cancel out the reverse end-cap effect T on the bottom of the riser. The buoyancy required of the buoy 8 to exert this tension remains reasonable given that the means recommended by the invention makes it possible to reduce the weight of the pipe.

FIG. 5 shows another embodiment in which tensioning means 8 are provided at the bottom of the riser. The nozzle 6′ at the bottom of the riser is firmly attached by cables to a weight 8 that slides vertically in a hole 36 formed in the seabed 5 and tubed. The formation of the hole 36 is made easier if the platform 3 is a drilling platform. The weight 8 imposes a permanent tensile force T at the bottom of the riser and the latter, according to the invention, is chosen to take up at least half the reverse end-cap effect. In order to accommodate the variations of the height h of the weight, the first coupling 30 is flexible and possibly includes floats 37.

FIG. 6 shows a variant of the invention in which the flexible riser 10 is not held taut in the vertical position but in catenary fashion. It extends between the surface installation 3 at sea level 4 and a flexible coupling 30 resistant to compression and connected to the flowline 2 on the seabed 5. The bottom nozzle 6′ of the pipe, which is situated above the seabed 5, at a certain distance, supports a weight 8 which imposes a force T2 directed vertically downwards on this nozzle, which corresponds to a force T related to the tangent to the axis of the pipe at its end by a value of T2/cos α, if a designates the angle formed between the bottom of the pipe and the vertical. According to the invention, the weight 8 is chosen so that T takes up at least 50% of the calculable reverse end-cap effect that can be applied to the bottom end of the pipe 10. The weight 8 may be divided into several weights. Instead of being suspended, it may be attached by ballast clamps to the pipe, represented as 8′″.

Regarding the installation of the inventive pipe, it is advantageous to lay the flexible pipe full of water, either totally or partially, so as to limit the reverse end-cap effect during the laying operation, until the tension T has been applied. In practice, the column of water inside the flexible pipe generates an internal pressure which opposes the external hydrostatic pressure, and reduces the reverse end-cap effect. It is thus possible, by adjusting the water level inside the flexible pipe, to reduce and permanently control the axial compression stresses supported by the flexible pipe during the laying operation, so as to avoid damaging said pipe. Once the tension T is applied, the riser can be emptied by pumping the water used during the prior installation phases, without risk of damaging the vertical flexible pipe. Replacing the water with another fluid, such as a gas oil-type hydrocarbon for example, would not represent a departure from the context of the present invention. This solution would be particularly suited to the laying of flexible pipes transporting gas, because the presence of water or moisture inside these pipes is likely to subsequently result in the formation of hydrate plugs.

1. A riser installation, comprising:
a flexible pipe of the unbonded type, the pipe comprising, from inside to outside, at least one internal sealing sheath and at least two layers of tensile armor wires wound with a long pitch;
the pipe having a top toward a sea surface and a bottom toward a sea bed;
a top mechanical connection at the top of the pipe to an installation at the sea surface; a bottom mechanical connection at the bottom of the pipe to the sea bed;
the pipe being positioned between the top mechanical connection at the top to a surface installation and the bottom mechanical connection at the bottom of the pipe with the seabed;
fluidic connections at the top and the bottom of the pipe to connect the riser respectively to surface equipment and to seabed equipment,
the flexible pipe is positioned with the bottom of the riser at a sea depth of at least 1000 m where the riser is subject to a maximum calculable reverse end-cap effect F;
a tensioning device at the bottom of the riser, configured to produce, at the bottom of the riser, a reactive tension T greater than at least 50% of the maximum calculable reverse end-cap effect F developed at the bottom of the riser.

2. The installation as claimed in claim 1, wherein the tensioning device is configured to exert on the riser a tension T greater than at least 75% of the maximum reverse end-cap effect F developed at the bottom of the riser.

3. The installation as claimed in claim 1, wherein the tensioning device is configured to exert on the riser a tension T greater than at least 100% of the maximum reverse end-cap effect F developed at the bottom of the riser.

4. The installation as claimed in claim 1, wherein the tensioning device is incorporated in the surface installation.

5. The installation as claimed in claim 4, wherein the tensioning comprises a hydraulic tensioning device.

6. The installation as claimed in claim 4, wherein the tensioning device comprises a float fixed toward the top of the pipe;
the surface installation has a guide therein for guiding the floating motion of the float, and the float slides in the guide inside the surface installation.

7. The installation as claimed in of claim 1, wherein the tensioning device is situated at the bottom of the riser.

8. The installation as claimed in claim 7, wherein the tensioning device comprises a weight connected to the bottom portion of the pipe.

9. The installation as claimed in claim 8, further comprising a hole in the sea bed, and the weight slides in the hole provided in the seabed.

10. The installation as claimed in claim 8, wherein the weight is distributed over a portion of the pipe toward the bottom end of the pipe.

11. The installation as claimed in claim 1, wherein the riser is positioned vertically in the sea.

12. The installation as claimed in claim 1, wherein the inventive riser is suspended in catenary fashion and weights positioned at the bottom of the pipe for holding the riser out.

13. The installation as claimed in claim 1, wherein the pipe comprises tensile armor made of a composite, carbon fiber-based material.

14. The installation as claimed in claim 1, wherein the tensile armors are made of a composite, glass-fiber-based material.

15. A method of installing a riser installation using a flexible pipe of the unbonded type, the pipe comprising, from inside to outside, at least one internal sealing sheath and at least two layers of tensile armor wires wound with a long pitch, the method comprising:
positioning the pipe between a mechanical connection at the top of the pipe to a surface installation at the sea surface and a mechanical connection at the bottom of the pipe with the seabed;
connecting fluidic connections at the top and at the bottom of the pipe to connect the riser to surface equipment and to seabed equipment;
positioning the bottom of the riser at a depth of at least 1000 m where the riser is subject to a maximum calculable reverse end-cap effect F; and
applying a tensioning device to the bottom of the riser, to produce a reactive tension T greater than at least 50% of the maximum calculable reverse end-cap effect F developed at the bottom of the riser.

16. The method as claimed in claim 15, further comprising:
filling the flexible pipe with water while laying the pipe before and during connecting the pipe.
